(19) United States
(12) Patent Application Publication
(10) Pub. No.: US 2004/0059944 A1
(43) Pub. Date: Mar. 25, 2004

(54) System and method for repelling attack data streams on network nodes in a communications network

(76) Inventor: Rainer Stademann, Egmating (DE)

Correspondence Address: Kevin R. Spivak, Morrison & Foerster LLP, Suite 300, 1650 Tysons Boulevard, McLean, VA, 22102, US

(21) Appl. No.: 10/253,895

(22) Filed: Sep. 25, 2002

(51) Int. Cl. G06F 11/30

(52) U.S. Cl. 713/201

(57) ABSTRACT

Method for repelling attack data streams on network nodes in a communications network which provides a transmission channel for transmitting a service between a service-providing network node and a service-requesting network node, the service-providing network node providing the service in successive time intervals at respectively different active network addresses which it agrees beforehand with a class of service-requesting network nodes.

### CHARACTERIZATION OF THE INVENTION

The invention relates to a method and a device for repelling attack data streams on network nodes in a communications network which provides a transmission channel for transmitting a service between a service-providing network node and a service-requesting network node.

### PRIOR ART

A communications network connects locally distributed communication partners for the purpose of transmitting or interchanging information for specific aims. The telecommunications network is an international communications network which provides the subscribers with the opportunity for interpersonal communication on a global scale. Initially, the telephone networks were designed on a regional basis and exclusively for transmitting voice information; today they are interlinked throughout the world and transmit not only voice information but also data. The physical transmission path is formed by a sectional network which strings together path sections on a section-by-section basis using switching nodes. Switching nodes are essentially computers which have the task of controlling and transmitting the traffic stream of user information.

In recent years, incomparable growth in the numbers of subscribers, in the performance capability and in technological progress has resulted in the Internet being developed into an interservice instrument which is becoming increasingly significant both in the commercial and in the private sector. The Internet is a worldwide computer network comprising a multiplicity of autonomous networks with different capabilities. The nodes in the network act, depending on their role, as a service-requesting location or as a service-providing location, i.e. as a client or as a server. The Internet is organized on a local basis. In contrast to the variety of standardizations and standards for the telephone networks, international organizations for the Internet merely meet recommendations. There is no central management and also no central operation.

Recently, voice and data networks have become more and more difficult to distinguish. The telecommunications network and the Internet are growing together more and more. The Internet is increasingly also involved in the setup of telephone connections, “voice over IP connections”.

Attacks on Internet servers have recently gained great public attention. As a result of these attacks, network nodes in the Internet have not been operational for several days. Services provided in the network have been inaccessible to end users. One principle of these attacks is based on sending a very large number of access commands or requests to a network node and exhausting the computer's resources through a flood of data. The aim is to cripple the computer as a result of the attack or at least to restrict its operations severely. An example of this is the “SYN attack”. This makes use of the fact that network nodes acting in a client and server role on the Internet often execute a three-way handshake mechanism. This mechanism, which is organized in the Transmission Control Protocol (TCP) and is produced for “half-open” connections between the communicating computers, is particularly vulnerable in the event of an attack: the client sends a synchronization message (SYN) to the server, which responds with a corresponding acknowledgement (ACK/SYN). The client then sends its acknowledgement (ACK) to the server. At that point, the “Denial-of-Service attack” (DoS) attacks and makes use of the fact that the server has to store the half-open connections before it receives a response. In the case of the misuse, however, this response is never given. The server has to hold all the half-open connections in the memory. However, the attacker continually sends a flood of such requests to his victim. In the case of one attack variant, the “Distributed Denial of Service attack” (DDoS), a number of attackers are involved. These attackers are distributed in the network. As the resources of the attacked server network node are increasingly used up, a situation can quickly arise in which said node can no longer react to requests from its clients. From the point of view of the client, the server is rejecting the service it has requested. A situation can arise in which the memory of a server attacked in this manner overflows and the server crashes. The server is then crippled in the network. If a telephone call is conducted via a server attacked in such a manner, a situation can arise in which the Voice-over-IP connection is interrupted.

Various methods for repelling attacks on network nodes are known. One option for repelling attacks is authentication of the location requesting the service, for example using devices such as are known by the collective term firewall. A firewall is a protective measure which comprises hardware and/or software components and a set of further rules and protocols which monitor and limit access between a network which is to be protected and the Internet. In practice, a firewall can be designed such that the computer providing the actual service has a powerful device connected upstream of it which checks the authorization of all service requests arriving using passwords or using cryptographic technology, such as electronic signatures. However, even if a computer is equipped to identify fake messages, the protection is often inadequate, since the attacker will always try to disguise his fake message as far as possible.

### DESCRIPTION OF THE INVENTION

It is an object of the invention to specify a method and a device such that network nodes in a communications network can be better protected against attack data streams.

The invention achieves this object for a method of the type mentioned in the introduction by means of the characterizing features of patent claim 1, and for a device by means of the features of patent claim 12. The respective subclaims refer to advantageous refinements of the invention.

The inventive method makes provision for the service-providing network node to provide the service not at one fixed address, but rather in successive time intervals at different active network addresses which it has agreed beforehand with a class of selected service-requesting network nodes. In contrast to the use of a static network address, the invention thus proposes varying the network address over time. To accept a service request, the server has the prerequisite that the requesting party knows the service's network address which is valid at any one time and that the requesting party belongs to a class of network nodes which is authorized to request the service. Only authorized service users know at what time and at what address or at what addresses the service is available in each case. This means that only authorized clients can send a request to a server. The risk that, by way of example, half-open connections will be generated by unauthorized clients for the purpose of misuse is thus largely reduced. Since the network addresses are constantly altered, the likelihood of requests for purposes of misuse in the network being able to cripple a network node is reduced.

It is particularly advantageous if the service-providing network node provides the service at a set of network addresses of which only a subset is active in a time interval. This firstly allows the service to be provided efficiently, and secondly an attacker is effectively countered.

A plurality of network addresses for a service provide a simple way of distributing the load from the service requests over a plurality of servers on a server farm. This firstly allows more service requests to be handled, and secondly the service availability increases, since, in the event of one server failing, the service can be maintained by the other servers on the server farm. Furthermore, even in the event of a successful attack on one of the addresses, the service continues to be available at the other addresses. In practice, server farms having between two and approximately 50 servers are customary.

It is particularly advantageous if the service-providing network node ascertains the active network addresses from a specification which is known only to the service-providing network node and to the class of selected network nodes. This makes it particularly difficult for an attacker who does not know the secret agreement between client and server to attack a server successfully.

A secret list, containing entries, which is used as a basis for altering the subset of active network addresses is a particularly easy-to-operate form of the agreement in this context.

Another particularly simple refinement is when the service-providing network node and the service-requesting network node calculate the next subset of network addresses which is to be used using pseudo-random number generators. To this end, the network nodes agree, for every active network address, a common, secret “seed” which is used to initialize a pseudo-random number generator. A “seed” is a very large, generally natural, number from which a pseudo-random number generator can calculate an infinite succession of randomly appearing numbers. The nature of the numbers in this succession is such that they satisfy fundamental criteria for statistical independence (randomness criteria). Nevertheless, the entire succession of numbers is determined completely by the “seed” used. The pseudo-random numbers generated in this manner are used to calculate the next active network address. Since all authorized network nodes have used the same secret “seed” to initialize their pseudo-random number generators, all the network nodes will calculate the same pseudo-random numbers and hence also the same active network address. This embodiment of the method avoids interchanging large volumes of secret data.

In one particular refinement, the invention provides for the service-providing network node to transmit the current active network addresses to the service-requesting network nodes.

In this context, it is beneficial if the current active network addresses are transmitted in encrypted form so that a potential attacker cannot monitor them. This can be achieved using the inherently known methods of encryption. The advantage of this refinement is that the service-providing network node can itself change the active network address(es) at any time without all the service-requesting network nodes needing to be provided with new secret data beforehand. The service-providing network node can thus react to attacks immediately by changing the active network address(es). This allows the service availability to be increased despite minimal address change.

It can also be advantageous if the service-requesting network nodes send cyclic requests to the service-providing network node and use a query to ascertain which network addresses are active. This moves the activity for attack repulsion to the client and relieves the load on the server.

It is particularly advantageous if the service-providing network node authenticates the class of selected network nodes, said authentication comprising the following steps:

1) the network source addresses of incoming service requests are detected;

2) the network source addresses are compared with an entry comprising selected network source addresses; and

3) the service request is processed if there is a match, and the service request is rejected if there is no match. The server thus automatically rejects all messages which do not originate from an active source address and are sent to an active destination address. It is highly unlikely that an attacker will find out both the active address of a requesting computer and that of a service-providing computer. This largely prevents misuse.

The inventive device is formed by a firewall which comprises a client-end protective device (F) connected between a service-requesting network node (C) and a communications network (IP network), and a server-end protective device (G) connected between a service-providing network node (S) and the communications network (IP network). The client-end protective device (F) is set up such that it uses a specification to convert a destination IP port number in an IP packet sent by the client (C) into an active IP port number for the server-end protective device (G). The server-end protective device is set up such that it converts the active IP port number into an IP port number for the server. In this case, both protective devices respectively access memory means (L) which contain a specification used as a basis for altering active network addresses. The specification is secret, i.e. it is known only to the server and to the authorized client(s).

A simple embodiment of the invention can thus be in a form such that the specification contains a table which contains an association between time intervals and active network addresses.

### BRIEF DESCRIPTIONS OF THE DRAWINGS

The subject matter of the invention is illustrated in more detail below with reference to the drawings, in which:

FIG. 1 shows a layer model for the client-server communication on the Internet;

FIG. 2 shows a schematic illustration of an attack scenario on a service-providing network node on the Internet;

FIG. 3 shows a graph illustrating the use of the inventive active network addresses as a function of time;

FIG. 4 shows a schematic illustration of a particular refinement of the invention in which active source addresses for the clients authenticate the requests;

FIG. 5 shows a schematic illustration of a firewall in accordance with the invention.

### EXPLANATION OF THE INVENTION

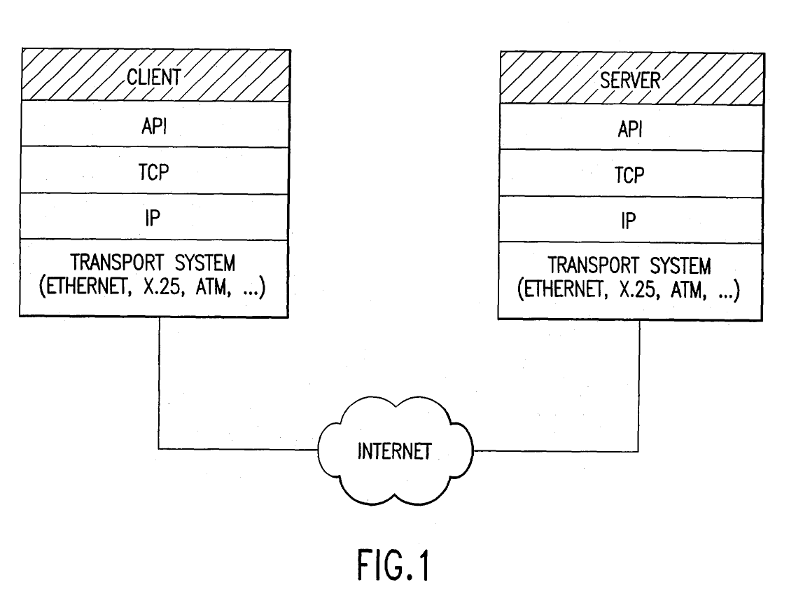

FIG. 1 shows a layer model for the client-server communication, as is the basis for handling a service request on the Internet. In the layer model, the Internet service is based on a specific programming interface (Application Programming Interface) (API) directly on the Transmission Control Protocol (TCP) and the Internet Protocol (IP). From there, the service is addressed using port numbers. When addressing a computer on the Internet, a user uses a domain name for which it is necessary to ascertain the IP address using the Domain Name Service (DNS) before the start of transmission. IP address and hardware address are associated by the Address Resolution Protocol (ARP), a protocol on the IP protocol layer. Situated on the bottommost level of the layer model is the transport system, for example in the inherently known standards Ethernet, X.25, ATM.

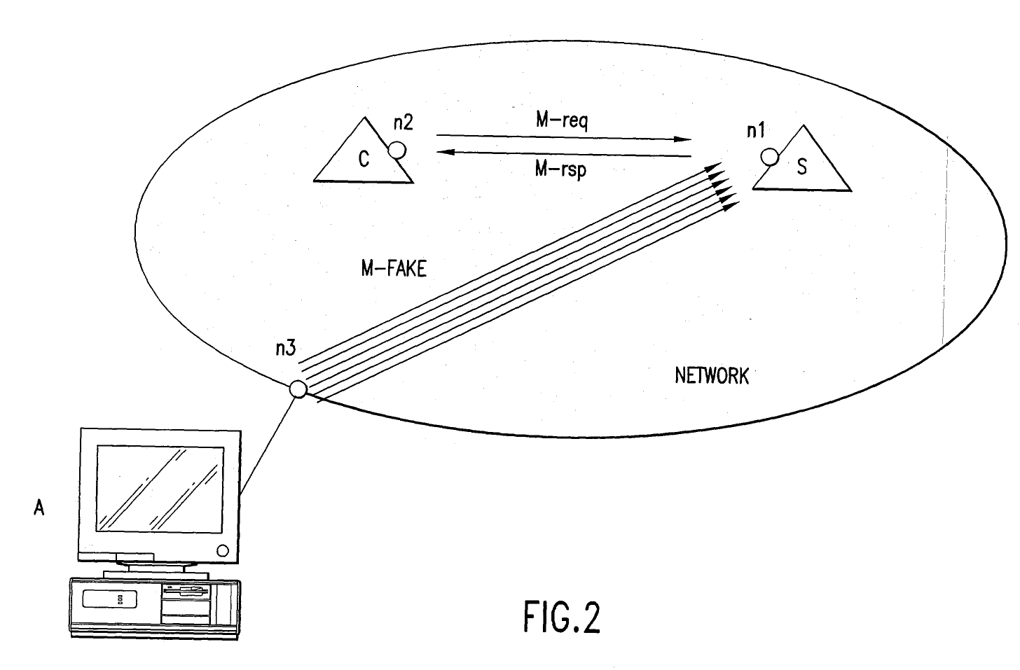

FIG. 2 shows an attack scenario on a computer S which, in the role of a server, is connected to a second computer C, which is acting as a client. With the intention of misuse, a communications subscriber A sends an attack data stream M-fake to the client C. The attack data stream M-fake is aimed at the half-open connection of the TCP protocol: to this end, the client C sends a request message (M-req) to the network address n1 of the server S. The server S responds with a message M-rsp, which it sends to the network address n2 of the client C. The subscriber A also sends service requests to the server from his access n3. As illustrated in the introduction, each of these requests results in a storage operation on the server. Since the acknowledgement is never sent by subscriber A, the attack can result in the server's memory resources quickly being used up and the computer crashing.

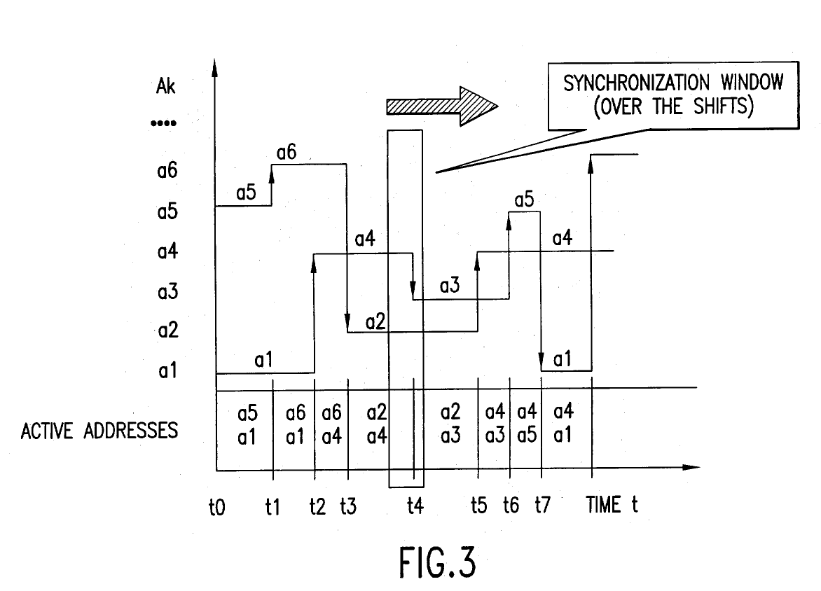

FIG. 3 uses a graph to show the use of the inventive active network addresses as a function of time. A service is provided not at one fixed network address n1 but rather at a set of network addresses a1, a2, . . . In one time interval, only a subset of these network addresses is accepted by the server S. In the example shown in FIG. 3, incoming messages containing service requests in the first time interval, i.e. from time t0 to time t1, are accepted only at the network addresses a1 and a5. In the next time interval t1 to t2 they are accepted at the network addresses a1 and a6, in the time interval t2 to t3 they are accepted only at the active network addresses a4 and a6, etc. A “synchronization window” moved along the time axis can be used to prevent client and server from always having to be synchronized exactly. To this end, the server also accepts service requests for network addresses which belong to adjoining time intervals, as long as these time intervals are covered fully or in part by the synchronization window. This means that the addresses in a past time interval are also valid during a transition time which corresponds to the width of the synchronization window. In the instantaneous illustration shown in FIG. 3, the synchronization window covers the two time intervals around t4. In this synchronization window, the service can already be called up at the new address a3, but can also still be called up at the old address a4 and at the unaltered address a2. The synchronization window permits simple synchronization between client C and server S.

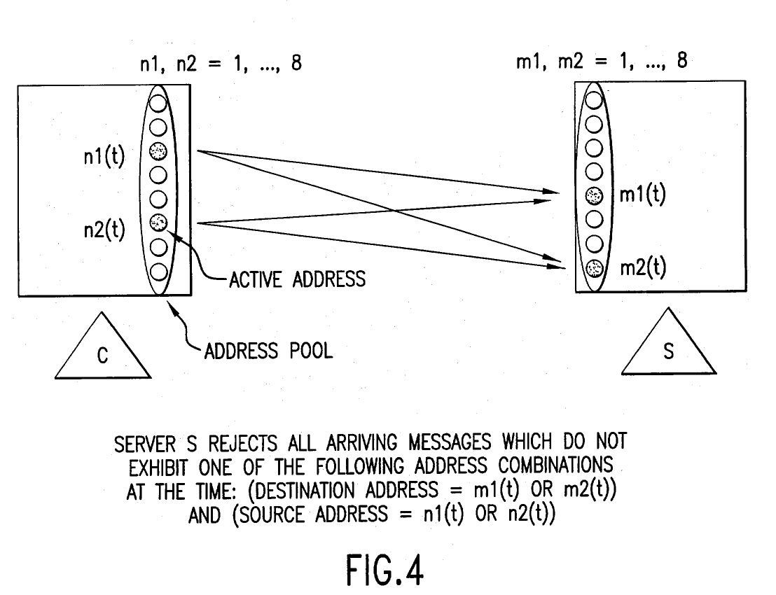

FIG. 4 shows a specific embodiment of the inventive method in which active source addresses for the clients authenticate the requests. The server S only accepts requests if they are firstly made by a correct active network address and secondly come from a particular network address. An authorized request needs to satisfy two criteria: firstly, the destination address needs to be correct, and secondly the request needs to come from a particular source address. FIG. 4 shows this schematically. Client C and server S use a plurality of addresses from an address pool. The addresses are shown in FIG. 4 by circles; active network addresses have a grey background. In the illustration shown in FIG. 4, only eight addresses are shown for the sake of simplicity. In reality, client C and server S naturally manage several tens of thousands of network addresses. At the time shown, the server S only accepts requests which are sent to m1 and m2 and come from n1 or n2. At this time, the server rejects all incoming messages which cannot be associated with the destination address m1 or m2 and with the source address n1 or n2. The security of the method can be increased further if, besides the active destination address, the source address is also varied over time. In FIG. 4, these active source addresses n1(t) and n2(t) have a grey background. The likelihood of an attacker finding out an active combination of these network addresses by chance is extremely low.

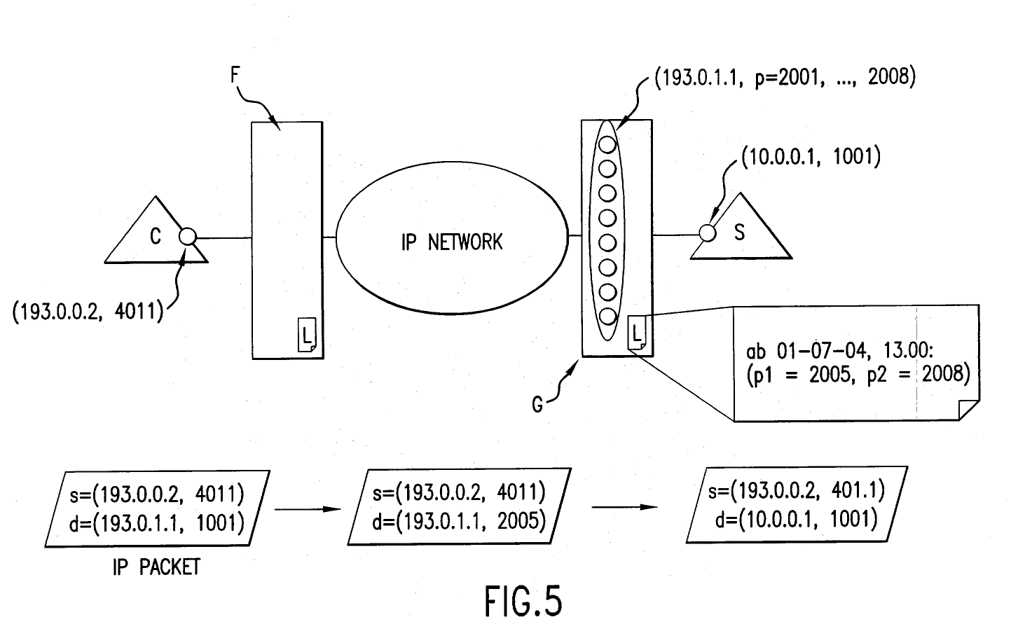

A device in accordance with the invention is shown in a simplified schematic illustration in FIG. 5. The firewall is produced by additional protective devices which respectively isolate the server S and the client C from the IP network. The inventive method is implemented in these units. Upon the request for a service, IP packets are sent from the clients to the server S. The text below uses the normally used decimal point notation for showing the IP addresses. The 32-bit binary character string is divided into four groups containing eight bits each. The server S has an associated private network address 10.0.0.1. It provides a service at the port 1001. In FIG. 5, the server S is isolated from the Internet by the device G. The client C has the network address 193.0.0.2. It sends a request in the form of an IP packet with the destination address d to the network address of the firewall 193.0.1.1. The IP packet contains the source address s of the client C (see IP packet at the bottom left in FIG. 5). From the point of view of the client C, the firewall G represents the server S; device G acts as a proxy for server S. The request is sent from the client to the destination port 1001 for the service provided by the server S. As can be seen in FIG. 5, the client is also not connected to the IP network directly, but rather via an additional device F. In the example, the destination port address 1001 in all the IP packets sent by the client C is converted into the address 2005 by the unit F before the IP packet is routed further to the IP network. On the basis of the destination address 193.0.1.1, the IP packet arrives at the device G. The device G can be addressed using a pool of eight network addresses. In the illustration shown in FIG. 5, these eight network addresses 2001 to 2008 are shown as circles. The device G, like F, stores the secret list L. This list shows which of the eight addresses are active. In the example shown in FIG. 5, p1=2005 and p2=2008 are valid from 07-01-04, 13.00, i.e. only these two addresses are active. Expressed in another way, the device G rejects all requests which are not sent to p1=2005 or p2=2008 from this time onward. In the accepted IP packets, the device G replaces the destination IP address with the IP address 10.0.0.1 of the server S. In addition, the device G replaces the port number of the destination with the port number 1001 of the server S. This means that the IP address and the hardware address of the server are again entered at the destination address d in the IP packet.

The inventive devices G and F for the firewall can be produced using hardware, software or firmware. The devices G and F can thus be external units which are connected into the connecting line to the IP network. The invention can naturally be used both for repelling attacks from one location (DoS) and for repelling attacks from a number of locations in the network (DDoS).

1. A method for repelling attack data streams on network nodes in a communications network which provides a transmission channel for transmitting a service between a service-providing network node (S) and a service-requesting network node (C), characterized in that the service-providing network node (S) provides the service in successive time intervals (t0-t1, t1-t2, . . . ) at respectively active network addresses (a1, a2, . . . ) which it agrees beforehand with a class of selected service-requesting network nodes.

2. The method as claimed in claim 1, characterized in that the service-providing network node (S) provides the service at a set of network addresses of which only a subset is active in a time interval.

3. The method as claimed in claim 2, characterized in that the set of network addresses is altered over time (FIG. 3).

4. The method as claimed in at least one of claims 1 to 3, characterized in that the service-providing network node (S) ascertains the active network addresses from a specification which is known only to the service-providing network node and to the class of selected network nodes.

5. The method as claimed in claim 4, characterized in that the specification is a secret list (L), containing an entry, which is used as a basis for altering the subset of active network addresses.

6. The method as claimed in claim 4, characterized in that the service-providing network node and the class of selected network nodes calculate the next subset of active network addresses which is to be used using a pseudo-random number generator, with all pseudo-random number generators being initialized by the same “initial number” (“Seed”), which is known only to the above network nodes.

7. The method as claimed in claim 4, characterized in that the service-providing network node transmits the current active network addresses to the service-requesting network node.

8. The method as claimed in claim 7, characterized in that the transmission is effected in encrypted form.

9. The method as claimed in claim 4, characterized in that the service-requesting network nodes send cyclic requests to the service-providing network node and use a query to ascertain active network addresses.

10. The method as claimed in at least one of the preceding claims, characterized in that the service-providing network node produces an authentication for the class of selected network nodes, the method comprising the following additional steps:
1) the network source addresses of incoming service requests are detected;
2) the network source addresses are compared with an entry in a table
3) the service request is processed if there is a match, and the service request is rejected if there is no match.

11. The method as claimed in claim 10, characterized in that the network source addresses are altered over time.

12. A firewall for repelling an attack data stream on a network node in a communications network, comprising a client-end protective device (F) connected between a service-requesting node (C) and a communications network (IP network), and a server-end protective device (G) connected between a service-providing network node (S) and the communications network (IP network), characterized in that the client-end protective device (F) comprises first means which use a specification to convert a destination IP address and port number in an IP packet sent by the client (C) into an active IP address and port number for the server-end protective device (G), in that the server-end protective device comprises second means which convert active IP address and port numbers into an IP address and port number for the server (S), the first and second means respectively accessing memory means (L) which contain a common specification used as a basis for altering active IP address and port numbers (network addresses).

13. The firewall as claimed in claim 12, characterized in that the specification contains a table which contains an association between time intervals and active network addresses (IP address and port numbers).
